(19) United States
(12) Patent Application Publication
(10) Pub. No.: US 2005/0226509 A1
(43) Pub. Date: Oct. 13, 2005

(54) Efficient classification of three dimensional face models for human identification and other applications

(76) Inventors: Thomas Maurer, Santa Clara, CA (US); Roman Waupotitsch, Santa Fe, NM (US); Gerard Medioni, Los Angeles, CA (US); Igor Maslov, Mountain View, CA (US); Alexei Tsaregorodtsev, Los Gatos, CA (US)

Correspondence Address: FISH & RICHARDSON, PC, 12390 EL CAMINO REAL, SAN DIEGO, CA, 92130-2081, US

(21) Appl. No.: 11/096,285

(22) Filed: Mar. 30, 2005

Related U.S. Application Data
(60) Provisional application No. 60/558,055, filed on Mar. 30, 2004.

(51) Int. Cl. G06K 9/00; G06K 9/46; G06K 9/66

(52) U.S. Cl. 382/190; 382/118

(57) ABSTRACT

Three dimensional face recognition via vectorizing samples that are in an enrollment data base. The vectors are formed by comparing faces in the enrollment database with reference faces, and determining differences between the actual faces and the reference faces. Those differences are then formed into an N dimensional vector representing the classified faces. A query face is then similarly vectorized and compared to precomputed vectors indicative of the faces in the database. Another technique is described for updating the reference faces based on an error level.

This application claims priority from Provisional application No. 60/558,055, filed Mar. 30, 2004.

### BACKGROUND

Geometrics Inc., the assignee of this application, has technology that relates to human identification using three-dimensional models of persons faces. This technology is described in application numbers 2002-0024516; 2004-00223630 and 2004-0223631.

A face recognizer of this type relies on a database of three dimensional face models, called an enrollment database. The three dimensional face models in the enrollment database may be models that have been captured, for example, by a three-dimensional scanner device such as a laser scanner or a stereo camera system. Each face in the enrollment database is associated with identification information for the person associated with that face.

A three dimensional human face of unknown identity forms the query to the database. The system then needs to find a model or models from the enrollment database that have the best similarity with the query model. Subsequent processing may be used to determine if this most similar database entry is the same or a different identity. One aspect may simply report whether the person was found in the database or not.

Other face recognition applications can be done with this system. The recognition relys on matching of three dimensional face/head shape.

### SUMMARY

The present application describes a way of classifying the face models in an enrollment database in order to allow faster comparison to search through a larger number of face models. One aspect describes comparing the faces to reference face shapes and storing differences, and using those differences as a query into the database. Another aspect describes updating of the reference faces.

### BRIEF DESCRIPTION OF THE DRAWINGS

These and other aspects will now be described in detail with reference to the accompanying drawings, wherein:

FIG. 1 shows a block diagram of a identification system of this type.

FIG. 2 shows a flowchart of company vectors;

FIG. 3 shows forming the vectors; and

FIG. 4 shows a flowchart of updating the reference faces.

### DETAILED DESCRIPTION

A brute force method of comparing the query to the enrollment database simply compares the query face against each database entry, one after another. The query may be mathematically compared against the database to find entries in the database, for example, with least mean squares differences less than a specified amount.

Such a method may become extremely computationally intensive, especially for large databases. The computational complexity is proportional to the number of entries in the database. This causes the search time to scale in proportion to the number of entries in the database. The disclosed embodiments address this issue.

An embodiment is shown in FIG. 1. An enrollment database 100 is shown, connected to a 3-D image obtaining part 110 and a user interface part that allows entering identification information associated with the enrollees in the database. The 3-D imaging part may be a laser scanner or stereo camera system. The enrollment database 100 also stores classification information 101 associated with at least a plurality of the entries in the database. Another 3D scanner 120 is located in a location to receive the subject query, that is the query of the person whose identification is to be obtained. The information from both the enrollment database and from the query is coupled to a computer 130 which compares the enrollment and query. The computer or computers used therein can be any kind of processor or computer of any type.

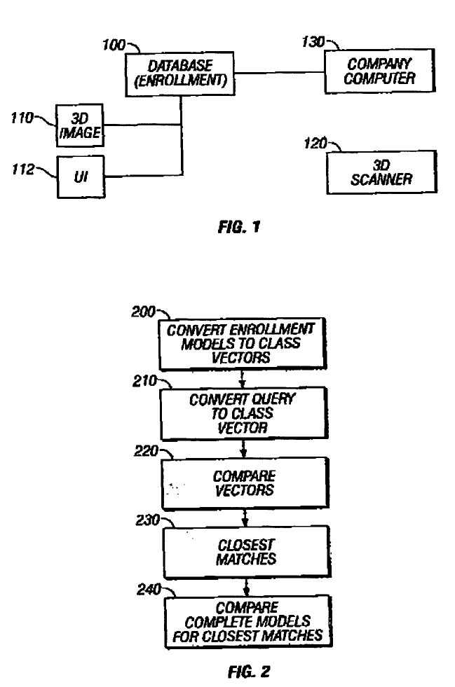

FIG. 2 shows a flowchart of operation of how the models are compared. The flowchart may be executed on multiple different computers.

At 200, models in the database are converted into an n dimensional classification vector. This conversion needs to be done only once for each model. The query face is similarly vectorized at 210. Each of the “vectors” represents individual characteristics of the face. At 220, the classification vectors are compared. These classification vectors are smaller than the original 3D models, and hence have less data, and can be compared much faster than the original models. The closest matches are identified at 230.

At 240, the closest matches are robustly rechecked, using the complete 3 dimensional model check. The vectors can be compared much faster than the complete model with a comparable overall accuracy for the system. The computationally intensive complete comparision is carried out for only the small subset of the database that is identified as matched.

The models are formed as shown in the flowchart of FIG. 3. At 300, a set of reference 3-D models are obtained. The set of reference 3 D models are used for comparison to the enrollment and query models. An optimal set of reference 3-D models may be obtained in various ways, one of which is simply by trial and error. In the embodiment, the models may be selected in a way that allows each of a number of different kinds of face shapes to be accommodated by one of the models.

At 310, the 3-D face model is compared with the 3 D models according to multiple, here N, specified criteria. Each criterion produces a score. There are N criteria, each forming a dimension of the vector. Each comparison may be, for example, an alignment. The 3-D face model of interest is aligned with each of the reference models using an alignment algorithm. One example alignment technique is The patent applications noted above. The alignment is then used to form at least one dimension of the vector.

The vector includes distance scores that are extracted from each alignment. This can be a least means squares relation between the full face shapes. Alternatively, this may use a more refined subdivision of the three dimensional face model into regions which provide a more detailed differentiation of facial shape. Certain reference models may have more definition in nose area, eyes or head and the like. For example, one model or set of models may be only for specific comparision with specific areas.

A dimension of the vector is built from the differences at 315. Each area computed after alignment and each 3-D reference model provides a distance score as a floating-point number. The distance scores collectively form an N dimensional vector. For example, if 4 reference face models are used to compare 7 local areas per face, then a 28 dimensional vector is obtained at 320.

The classification vector for the query face is computed and compared against the classification vectors for each of the enrollment models as computed. Any technique of comparing n dimensional vectors may be used. For example, this may calculate a Euclidean distance, or a normalized scale Mercador.

In one aspect, shown as 325, the vectorizing operation may ignore the most dissimilar quarter to third of the dimensions for each reference face.

In the embodiment, a larger classification score implies a better similarity. The 3-D enrollment models whose classification vectors are most similar to the challenge classification vector defines the set of candidate faces at 230. The most likely face may be the one with the highest classification score.

The system relies on the assumption that alignment of different 3-D face models of the same persons will yield the same or very similar alignment. This assumption holds when the 3-D model for the face is very similar. A problem may exist if face models are captured with different scanning systems in different lighting conditions. Certain aspects of the face model may also be dependent on the pose of the person, and on the person's facial expression. If the 3-D facemask does not satisfy the condition aligning different 3-D models of the same person to the same reference model, then a matching face shape might not be accurately obtained.

One embodiment addresses this issue by obtaining partial face masks in the enrollment database. Partial face masks can be used without changing the fundamental approach noted above. A smaller area reference face is obtained. However, in order to compensate for that smaller reference face area, the number of reference faces may be increased. The operation may use only one score per reference face, but have more reference faces; such as 15 reference faces.

An example of a facemask that is robust to facial expression may include a facemask that has only areas nose with the cheek and mouth excluded. This facemask is generally in the shape of a “T”.

The above has noted that this method is as accurate as the full set of one-to-one comparisons (that is the challenge 3-D model against every enrollment 3-D model) as long as the “correct” match is contained in the set of candidate matches at 320. Whether or not a match is contained in the set of candidate matches depends on the accuracy of the system. This can be determined experimentally for example. From four different databases containing up to 1000 face models, the inventors found a candidate set size of five to be sufficient in an embodiment.

The search time for the candidate faces is linear to the size of faces in the enrollment database. Additional improvement can be obtained by reducing the size down to sub linear performance. This may use geometric subdivision schemes such as binary space partitioning trees, Voronoi diagrams or similar. By reducing the number of elements to be searched, the search speed may correspondingly be increased. For example, the number of elements may be reduced to the order of the logarithm of the size of the database. Alternative methods may also be used which may increase searching speed in conjunction with the geometric schemes. Note that this technique may not change the “complexity”: Computation time remains linear to the number of faces enrolled in the database. However, the difference in speed is enormous: For the full face shape comparison, speed may be 2 face comparisons per second. For the vector comparison, speed is 1 million comparisons per second using comparable hardware, after the challenge face has been converted into the classification vector.

The set of the reference models may effect the performance of the system. Both the recognition rate and the query speed depend on the reference faces that are used. Any kind of reference can be used, for example a plane or a sphere could be used as a reference. However, experiments have suggested that 3-D models that are similar to the actual face models may perform the best. Different models may include artificially created models, randomly selected faces from a database of three-dimensional face models, or faces selected from a three-dimensional face database by a matching technique algorithm. The selection technique may use identification statistics to optimize the selection. The three-dimensional face model database may be dynamically tested and updated. It may be a combination of any of the above techniques.

Artificial 3-D face models may use 3-D modeling software such as Singular Inversions' Facegen Modeler to parametrically model a set of faces. 3-D software, such as 3-D studio Max may alternatively be used to create hypothetical faces.

Different ways of selecting reference faces from the database may be used. However, the general idea is to obtain an existing database of 3-D face models, and select from that database the 3-D face models the reference faces that provide the best performance or at least approach a very high performance. One aspect may measure the performance, for example.

To measure the performance, a 3-D face model database is used. For each face in the 3-D model database, the classification vector is computed. Then, each 3-D model in the database is chosen, and the set of candidate faces is computed for the 3-D face models in the databases. Several measures are extracted from these experiments that predict the performance of the system. One measure, for example, may be the number of times that the correctly matching face has been assigned the highest score. The corresponding measure is called the cumulative match statistic. Another measure is called the equal error rate, or EER, described in Krause, et al., Handbook of Information Security Management, CRC Press LLC, 1997. EER is defined as EER=FRR=FAR. The performance of a recognition system can be visualized by plotting FRR over FAR. The system can be configured tight, resulting in low FAR, but larger FRR. Alternatively, the system can be configured loose, resulting in larger FAR but smaller FRR. EER is defined as the point where FRR=FAR.

Random reference 3-D face model selection may also be used. The size of the random set directly affects the computation time of creation and comparison of the multidimensional vectors. Therefore, the size of the set may be selected taking into account the desired computation time. An exemplary size may be between 5 and 10. One operation may generate several of these sets. Each set may be tested. The best-performing set is selected as the set to be used.

This approach, unfortunately, may provide limited control over performance. The reference set which is often best performing, has different reference models which are as different or independent as possible. When the faces are randomly selected, two of the faces may be similar or even the same. In that case, the second reference face does not carry any additional information.

A fixed training database may produce the set of reference faces incrementally using a greedy algorithm. A set of candidate vectors is computed, and the set that results in the best equal equal error rate is selected. After that, the system repeatedly adds the next best reference face and computes the equal error rate again. The process is terminated when the equal error rate is below a predetermined target threshold, or when the number of reference faces exceeds a certain threshold.

Measuring the equal error rate requires computing the distribution of the scores for faces of the same person, as well as the computation of the distribution of scores of comparisons between faces a different person. Unfortunately, if every face is to be compared with every other face, and then complexity becomes quadratic to the number of faces in the database for each equal error rate computation. It may not be necessary to compute all possible pairs, for example, the equal error rate can be approximated well by using only a small fraction of randomly chosen pairs of faces. Specifically, in order to determine the distributions with 1% error in a confidence value of 95%, approximately 2500 comparisons of same persons and 40,000 of different persons may be required.

To recite typical numbers, a typical set of reference faces has three to six reference faces for a database of several hundred faces. That number may vary depending on the number of local face regions that are used in creation of the classification. It may also depend on the faces that are specifically in the database.

Each element of the classification vector effectively categorizes a face to belong to a certain subspace of the subspace of all possible 3-D face models. Therefore, the size of the classification vector grows with the logarithm of the size of the face database.

Another aspect may use a dynamic set of reference faces from a changing enrollment database. A fixed training database may have certain advantages. However, the classification vector in such a fixed training database may not represent the faces well in the deployed database. For example, the training database may include an evenly distributed population. In contrast, the population of the deployed database may be skewed towards a particular ethnic group. As the database size of the deployed system increases, the number of reference faces that are chosen from the training database may not achieve optimal recognition rates.

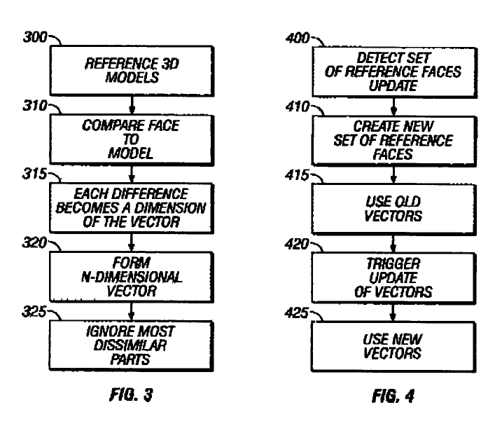

Another aspect uses a mechanism to dynamically update the set of reference faces. The updating is carried out according to the flowchart at FIG. 4. 400 represents determining that the set of reference faces needs to be updated. The performance of the classification vector is monitored as new faces are added and removed from the database. In some enrollment scenarios, there is only 1-30 face models per person. This may make the statistical analysis using EER not applicable since there are no truly matching faces in the database. The false acceptance rate for a specific score value can be used to estimate the performance of the system. Intuitively, a smaller false acceptance rate for a fixed score corresponds to a better performing system. The actual value for the score, and the threshold for the false acceptance rate for which a reference face update is triggered, may be extrapolated statistically, or may be selected by trial and error.

When the predicted performance slips below the predefined threshold at 400, the system will be triggered to create a new set of reference faces from the current 3-D face model database beginning at 410. Due to the dynamic structure of the 3-D face model database, the reference faces may need to be selected from a snapshot of the database at the time the decision is made that the reference faces need to be updated. Changes that are made while this update is performed may be assumed as insignificant. The selection of the new reference faces in the update of the classification vector for all the 3-D face models may be a computationally intensive and lengthy process.

The system may maintain multiple versions of classification vectors for each 3-D model, to allow use during the relatively lengthy process of updating the face model. For example, at 415, the system may use older versions of the vectors while creating the new set of reference faces. At 420, the new set of reference faces is completed, and the vectors are updated. After completing updating the vectors at 420, 425 represents using the new vectors. Classification vector IDs and increment lists that store the database operation are all completed before the new vectors are used.

The one-to-one verification at 240 may be the one-to-one comparison described in the above-cited patent applications, or alternatively may be a robust extension of that one-to-one comparison. A query face of a person that has some form of identification provides an index, e.g. name or number, into the enrollment database. This is compared to an enrollment phase to verify the claimed identity. This may use the techniques described in the above patent applications.

Since no system is perfect, there may always be uncertainty associated with the result that is obtained from such a comparison. For example, there may be a second face in the population that is very similar to the one face. It may be sufficiently similar that if the face were presented as a query face, that the one-to-one algorithm would not be able to distinguish it from the actual match. The robust verification reduces this uncertainty by using an additional one too many search of the query face in the 3-D face model database. If the face triggers many matching faces, the operator may be alerted to this. Depending on the application, this may cause additional identification to be requested, such as fingerprints or interactive human inspection.

The technique described above may be most effective in a “closed” database, that is, which contains exactly the 3-D face models of a set of people that have access to some resource in some facility. Persons may be added or removed from this database, depending on changing access conditions. A typical example of a closed database may be a prison in which the database has a 3-D face model of every prisoner in the prison. When a prisoner or guard leaves, the 3-D face model may be removed from the database.

Another similar application may include individual thresholds for one to one matches. Typical one-to-one scenarios include a threshold that defines whether or not an identity is established. This approach may work well in general but better recognition performance may be achieved when individual thresholds are used for every enrollment of face. An embodiment may set a global default threshold for every face as the absolute maximum beyond which the identity will be rejected. An individual threshold for every face is also computed. This threshold will be lower depending on the expected similarity of the enrollment phase to the faces of the remainder of the population. This is based on the concept that certain faces are more similar to other faces. Every face may have a certain shape difference score relative to ball other faces in a population. The mean and standard deviation of this score is a good indication about how similar of face is to the remainder of the population. For example, a small mean and large Sigma is an indication that the face is very similar to the remainder of the population. In this case, the match threshold for this person is set lower.

There may be many different ways of computing these thresholds.

One individual threshold may be based on intra distribution. There may be many enrollments per person, from different dates, containing typical variations of the person's face, hairstyle, clothes, facial expression and the like. All those can be matched against one another, and the resulting person or distribution of distance scores can be obtained. The technique may operate as follows. For each person, compute the mean and standard deviation. Take the largest distance score, and a safety margin, for example three times the standard deviation. Take the result as the new threshold for the person. If the threshold is larger than the global threshold, then remain with the global threshold for the person. Base each decision about acceptance and rejection on its own verification.

This scheme does not change for a fixed set. However, If new persons are added to the database without recomputing the threshold for all enrolled persons or at least for the one most similar to the newly enrolled person, than the error can increase. The above technique may require multiple enrollments per person, e.g., at different dates and times. In practice, this condition is usually not met.

A technique for computing a reliable threshold from a single enrollment is described. When a new individual is enrolled into the database, that new individual is matched against all other faces in the database. An analysis is made of the resulting distribution of scores. The smallest of these distances is selected as the threshold for the person. Each enrollment of a person therefore is assigned its own threshold.

Different versions of this individual thresholding are possible. One of these may include not choosing the minimum as the individual threshold, but instead choosing it to be 1% or some other fixed number.

Although only a few embodiments have been disclosed in detail above, other modifications are possible, and this disclosure is intended to cover all such modifications, and most particularly, any modification which might be predictable to a person having ordinary skill in the art. For example, while the above has arrived operation to match different face shapes, it should be understood that this can be used in any identification technique, and can be used along with other face matching techniques. One example, while the above has described the operation using 3D shape matching, it should be understood that this may be combined with other systems such as two-dimensional face recognition matching. For example, one aspect allows selecting the most similar 1% of the enrollment population using either a two-dimensional face recognition, or a texture similarity technique. The techniques described above can then be used for further recognition. Another aspect combines this with a two-dimensional face recognition technique in some other way. For example, the robust determination could be via a two-dimensional face recognition technique after the three-dimensional face recognition technique.

Also, only those claims which use the words “means for” are intended to be interpreted under 35 USC 112, sixth paragraph. Moreover, no limitations from the specification are intended to be read into any claims, unless those limitations are expressly included in the claims.

1. A method comprising
obtaining a plurality of reference faces;
obtaining a plurality of enrollment faces, representing faces about which information is already known;
comparing at least a plurality of said enrollment faces with said reference faces to produce a plurality of enrollment scores representing differences between each of the plurality of enrollment faces and said reference faces;
obtaining a query face, and comparing said query face with said reference faces to produce a plurality of query scores representing differences between said query face and said reference faces; and
comparing said query scores with said plurality of enrollment scores to determine matches between said query face and said plurality of enrollment faces.

2. A method as in claim 1, wherein said reference faces, said enrollment faces, and said query faces represent three dimensional face shapes.

3. A method as in claim 2, further comprising further processing said matches, by comparing a three dimensional face shapes between said query face, and said matches.

4. A method as in claim 2, wherein said plurality of query scores form a multiple dimensional vector, and said comparing scores comprises comparing vectors.

5. A method as in claim 3, wherein said further processing comprises comparing complete face shapes for said matches, to determine if more than one model in the database represents said face shape.

6. A method as in claim 2, wherein at least a plurality of said reference faces represents only a portion of a face shape.

7. A method as in claim 2, further comprising updating the set of reference faces.

8. A method as in claim 7, wherein said updating comprises determining a new set of reference faces, recomputing said scores, and using said new scores for said recognizing.

9. A method as in claim 7, further comprising monitoring an error in said matching, determining said error being higher than a specified amount, and updating the set of reference faces when said error becomes higher than the specified amount.

10. A method as in claim 1, further comprising comparing an aspect of said query face to said enrollment faces using a two-dimensional face matching technique.

11. A method comprising:
converting a plurality of three-dimensional enrollment models into N-dimensional enrollment model vectors, by comparing the plurality of enrollment models to reference models, obtaining differences between each of the plurality of enrollment models and each of the reference models, and using said differences to form said N dimensional enrollment model vectors;
converting a query model, representing a face to be recognized, into an n dimensional query model vector, by comparing the query model to said reference models, obtaining the differences between the query model and the reference models, and using said differences to form an N dimensional query vector;
comparing the query vector to said enrollment model vectors and producing information indicative of matches therebetween.

12. A method as in claim 11 further comprising comparing said at least one match to said three-dimensional models, by comparing the entire query model to the entire three-dimensional model representing said at least one match.

13. A method as in claim 11, further comprising determining multiple best matches between the query model and three-dimensional models representing said at least one match.

14. A method as in claim 11, further comprising monitoring for errors in said comparing, and updating said reference models based on said errors having a certain level.

15. A method as in claim 11, wherein said reference models comprise partial face masks, and said converting comprises comparing the models to the partial face mask.

16. A method as in claim 11 further comprising comparing an aspect of said query face to said enrollment faces using a two-dimensional face matching technique.

17. A method as in claim 14, wherein said monitoring for errors comprises monitoring a performance of said n dimensional vectors as the contents of the database are changed.

18. A method as in claim 11, wherein said comparing comprises determining if the query is within a specified threshold of one of the n dimensional vectors.

19. A method as in claim 18, wherein said specified threshold is different for different faces.

20. A method as in claim 18, further comprising using an individual threshold for each of a plurality of different faces.

21. A method as in claim 20, further comprising comparing a face to other faces, determining a score for said comparing, and using said score to determine said individual threshold.

22. A method as in claim 21, wherein said using said score comprises selecting a smallest score as the threshold.

23. A system comprising
a database, storing information about a plurality of enrollment faces, representing faces about which information is already known, and storing a plurality of enrollment vectors, representing differences between each of the plurality of enrollment faces and a plurality of reference faces;
a query station, that obtains a query face, compares said query face with said reference faces to produce a query vector representing differences between said query face and said reference faces, and compares said query vector with said plurality of enrollment vectors to determine matches between said query face and said plurality of enrollment faces, and produces information indicative of said matches.

24. A system as in claim 23, wherein said reference faces, said enrollment faces, and said query faces represent three dimensional face shapes.

25. A system as in claim 24, wherein said query station also further processes said matches, by comparing complete three dimensional face shapes between said query face, and said matches.

26. A system as in claim 24, wherein at least a plurality of said reference faces represents only a portion of the shape of the reference face.

27. A system as in claim 24, wherein said query station further operates to update the set of reference faces.
